(19) United States
(12) Patent Application Publication
(10) Pub. No.: US 2023/0226885 A1
(43) Pub. Date: Jul. 20, 2023

(54) THERMAL CONTROL SYSTEM AND METHOD FOR ELECTRIC VEHICLE

(71) Applicant: Lordstown EV Corporation, Lordstown, OH (US)

(72) Inventors: Paranjothi Gopalan, Lordstown, OH (US); Simone Palombi, Lordstown, OH (US); Vinodh Muruganandam, Lordstown, OH (US); Krishnaiah Gudlanarva, Lordstown, OH (US)

(73) Assignee: Lordstown EV Corporation, Lordstown, OH (US)

(21) Appl. No.: 18/097,088

(22) Filed: Jan. 13, 2023

Related U.S. Application Data
(60) Provisional application No. 63/299,825, filed on Jan. 14, 2022.

(51) Int. Cl. B60H 1/00; B60L 58/24; B60K 11/04

(52) U.S. Cl. CPC B60H 1/00885; B60H 1/00278; B60H 1/00899; B60L 58/24; B60K 11/04; B60H 2001/00307; B60K 1/00

(57) ABSTRACT

Provided is a thermal control system of an electric vehicle including a powertrain thermal architecture, a cabin heating layout, a battery thermal architecture, and a cabin cooling layout. Also provided is a method of operation of a thermal control system for an electric vehicle. Also provided is a method of operation of a heating, ventilation, and air conditioning (HVAC) system for an electric vehicle having an electric motor and an inverter.

### CROSS-REFERENCE TO RELATED APPLICATION(S)

The present application claims priority to U.S. Provisional Application No. 63/299,825 filed Jan. 14, 2022, the entire contents of which are incorporated herein by reference.

### TECHNICAL FIELD

The present disclosure relates generally to the field of thermal architecture for heating and cooling of electric vehicles and in particular for electric pickup trucks.

### BACKGROUND

Electric vehicles, including electric pickup trucks, are gaining increased prominence as part of an effort to reduce vehicle emissions and provide sustainable transportation. Electric powertrains provide drive torque for electric vehicles. Thermal control system components provide cooling and heating for components such as electric motors, inverters, and the battery of the electric vehicle. Thermal control system components also facilitate climate control for the electric vehicle cabin in order to achieve efficiency, performance, and comfort objectives.

### SUMMARY

Various embodiments of the present disclosure provide a thermal architecture that allows for independent cooling of powertrain components and heating for cabin climate control. Thermal management is carried out to reduce energy consumption for in-wheel motors and power electronics such as inverters.

One embodiment of the present disclosure relates to a thermal control system for an electric vehicle and methods of operation thereof. The thermal control system is configured such that a single cooling arrangement is structured to circulate coolant to both inverters and electric motors within the electric vehicle. In various embodiments, the system may be configured to include multiple circuits, including a front circuit, a rear circuit, and a cabin circuit, where the circuits facilitate cooling the inverters and electric motors in series such that the inverters receive coolant at a cooler temperature than a temperature of coolant received by the electric motors, and the cabin receives heated coolant to save energy while heating the cabin.

In various embodiments, the system may be configured to include a battery circuit. The battery circuit may be configured to control the temperature of a battery system. The system may also include one or more bypass lines to allow coolant to bypass a fluidly coupled radiator when the vehicle is cold to allow at least one of the inverters or the electric motors to warm up so that the inverters and electric motors work in the highest efficiency region, and also to save heat for warming the cabin. The system may include a plurality of temperature sensors, e.g., two temperature sensors, one upstream of the radiator and one downstream of the radiator. Information from the temperature sensors may be used to control the flow rate and temperature of the coolant through the system. Such control may be performed by monitoring (e.g., via one or more controllers operably coupled to the two temperature sensors) at least one of a temperature upstream or downstream of the radiator and adjusting, e.g., via a valve and/or a pump, a flow rate of the coolant through the system.

In various embodiments, a method of operation of a heating, ventilation, and air conditioning (HVAC) system for an electric vehicle having an electric motor and an inverter is provided. The method includes inputting, via an occupant of the vehicle, an input to a human-machine interface (HMI) system; utilizing predetermined or sensed current limits, power shedding levels, and/or radiator input temperature together with the occupant input to generate a control command; and adjusting the HVAC system based on the control command. Adjusting the HVAC system comprises performing cooling, through a circuit configured to facilitate cooling the inverter and the electric motor in series such that the inverter receives coolant at a cooler temperature than a temperature of coolant received by the electric motor.

In various embodiments, a method of operation of a thermal control system for an electric vehicle is provided. The method includes obtaining temperature information from a plurality of temperature sensors. Obtaining temperature information includes at least one of (i) monitoring a first temperature sensor of the plurality of temperature sensors, the first temperature sensor being located upstream of a radiator or (ii) monitoring a second temperature sensor located downstream of a radiator. The method includes at least one of (i) adjusting an operational setting of a heater to increase an amount of heat generated by the heater to increase temperature of a coolant or (ii) adjusting an operational setting of a pump to adjust a flow rate of the coolant through the thermal control system. The method further includes obtaining pressure information from a plurality of pressure sensors. Obtaining pressure information includes at least one of (i) monitoring a first pressure sensor of the plurality of pressure sensors and a temperature sensor, the first pressure sensor and the temperature sensor being located downstream of an evaporator and upstream of a compressor or (ii) monitoring a second pressure sensor of the plurality of pressure sensors, the second pressure sensor being located downstream of a compressor.

In some embodiments, the method further includes at least one of (i) adjusting the flow of refrigerant through a cabin circuit via a thermal expansion valve (TXV) based on the pressure and temperature information from the plurality of pressure sensors and the temperature sensor or (ii) adjusting the flow of refrigerant through a cabin circuit via an electronic expansion valve (EXV) based on the pressure and temperature information. The method still further includes operating a pump to control a temperature of a battery, wherein operating the pump comprises controlling flow of refrigerant to one or more of a chiller, a heater, a battery of the electric vehicle, an on-board charging module, and an auxiliary power module. The pump is further operable to control temperature of a powertrain, and operating the pump comprises circulating coolant through a circuit to cool an inverter and an electric motor in series such that the inverter receives coolant at a cooler temperature than a temperature of coolant received by the electric motor.

As set forth in various embodiments below, front and rear power train loop cooling is achieved by the exemplary configuration of components and thermal management techniques set forth herein. In particular, heat from power train components may be transferred to satisfy cabin heating requirements, thereby reducing the extent to which additional heat is supplied for cabin climate needs.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appended at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic representation of a thermal management architecture layout for a thermal control system, according to an exemplary embodiment.

FIG. 2 is a schematic representation of a powertrain thermal architecture and cabin heating layout for a thermal control system of an electric vehicle (EV), according to an exemplary embodiment.

FIG. 3 is a schematic representation of a battery heating and cooling and cabin cooling architecture layout for a thermal control system, according to an exemplary embodiment.

FIG. 4 is a flow diagram depicting compressor control operations carried out by the thermal control system for controlling battery and cabin temperature, according to an exemplary embodiment.

FIG. 5 is a flow diagram depicting radiator fan control operations carried out by the thermal control system for controlling heat dissipation requirements by a condenser and radiator, according to an exemplary embodiment.

FIG. 6 is a flow diagram depicting heating, ventilation, and air conditioning operations carried out by the thermal control system for controlling cabin temperature, according to an exemplary embodiment.

FIG. 7 is a flow diagram depicting pump control operations carried out by the thermal control system for controlling powertrain, battery, and cabin temperature, according to an exemplary embodiment.

FIG. 8 is a perspective view of a powertrain and cabin coolant circuit of a thermal control system, according to an exemplary embodiment.

FIG. 9 is a perspective view of a cabin heating circuit of a thermal control system, according to an exemplary embodiment.

FIG. 10 is a perspective view of a battery heating circuit of a thermal control system, according to an exemplary embodiment.

FIG. 11 is a perspective view of a battery cooling circuit of a thermal control system, according to an exemplary embodiment.

FIG. 12 is a perspective view of a cabin cooling circuit of a thermal control system, according to an exemplary embodiment.

FIG. 13 is a front perspective view of a coolant bottle assembly for a thermal control system, according to an exemplary embodiment.

FIG. 14 is a front view of a three-way valve for a thermal control system, according to an exemplary embodiment.

FIG. 15 is a front view of a two-way valve for a thermal control system, according to an exemplary embodiment.

FIG. 16 is a perspective view of a cabin pump for a thermal control system, according to an exemplary embodiment.

FIG. 17 is perspective view of a chiller for a thermal control system, according to an exemplary embodiment.

FIG. 18 is a layered heater for a thermal control system, according to an exemplary embodiment.

FIG. 19 is a pump (e.g., a powertrain pump) for a thermal control system, according to an exemplary embodiment.

FIG. 20 is a side perspective view of a condenser radiator fan assembly for a thermal control system, according to an exemplary embodiment.

FIG. 21 is a front perspective view of an air-handler fluidly coupled to a thermal control system, according to an exemplary embodiment.

FIG. 22 is a perspective view of an automotive DC to DC converter in an electric vehicle having a thermal control system, according to an exemplary embodiment.

FIG. 23 is a perspective view of an on board charging module for a high voltage (HV) battery in an electric vehicle having a thermal control system, according to an exemplary embodiment.

FIG. 24 is a perspective view of an inverter for a powertrain in an electric vehicle having a thermal control system, according to an exemplary embodiment.

FIG. 25 is a perspective view of a motor for a powertrain in an electric vehicle a thermal control system, according to an exemplary embodiment.

Reference is made to the accompanying drawings throughout the following detailed description. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a variety of different configurations, all of which are explicitly contemplated and made part of this disclosure.

### DETAILED DESCRIPTION

Embodiments described herein relate generally to electric vehicle thermal control systems and methods of controlling the same. The various concepts introduced above and discussed in greater detail below may be implemented in any of numerous ways, as the described concepts are not limited to any particular manner of implementation. Examples of specific implementations and applications are provided primarily for illustrative purposes.

Unless otherwise indicated, all numbers expressing quantities of properties, parameters, conditions, and so forth, used in the specification and claims are to be understood as being modified in all instances by the term “about” or “approximately.” Accordingly, unless indicated to the contrary, any numerical parameters set forth in the following specification are approximations. Any numerical parameter should at least be construed in light of the number reported significant digits and by applying ordinary rounding techniques. The term “about” or “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

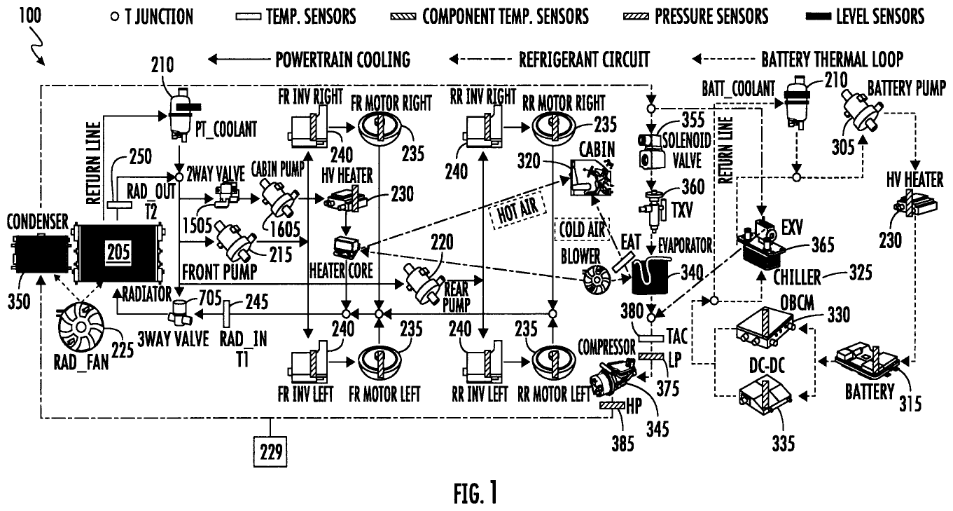

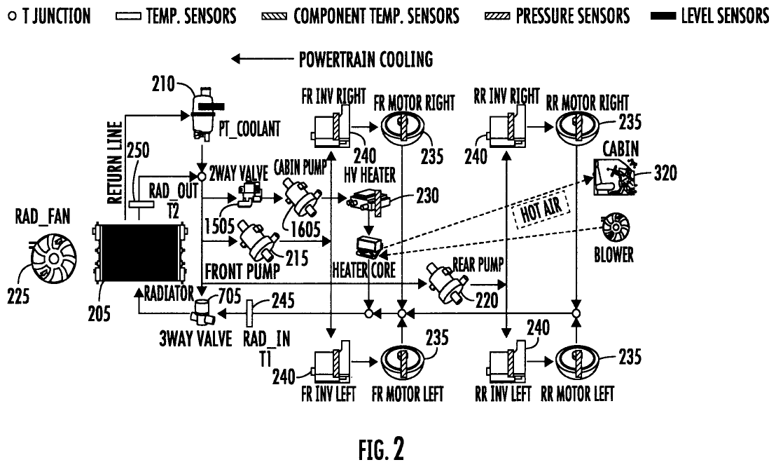

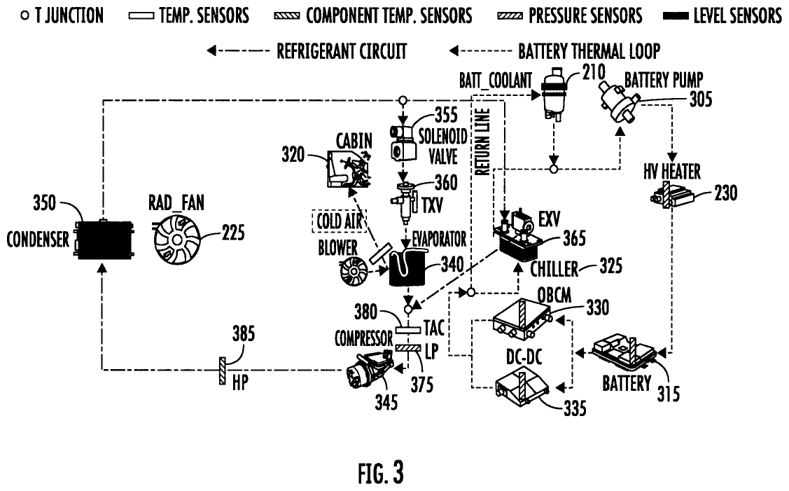

FIG. 1 is a schematic representation of a thermal management architecture layout for a thermal control system 100, according to an exemplary embodiment. As shown, the thermal control system 100 includes a powertrain thermal architecture and cabin heating layout for a thermal control system 100 of an electric vehicle (EV) as described below and shown in more detail in FIG. 2. The thermal control system 100 also includes a battery thermal architecture of the EV and a cabin cooling layout as described below and shown in more detail in FIG. 3.

The EV may be an all-electric vehicle (e.g., battery electric vehicle) that includes one or more electric motors and a battery pack (e.g., one or more batteries) that powers the electric motor(s). In an embodiment, the electric vehicle includes a separate electric motor for each wheel (e.g., an in-wheel electric motor, etc.). The electric vehicle may be an on or off highway vehicle including—but not limited to—a semi, a truck, a car, or any other vehicle type.

FIG. 2 is a schematic representation of a powertrain thermal architecture and cabin heating layout for a thermal control system 100 of an electric vehicle (EV), according to an exemplary embodiment. As shown, the thermal control system 100 includes at least one radiator 205, which is fluidly coupled to one or more fluid conduits that facilitate flow of coolant (i.e., thermal exchange fluid) to the powertrain of the EV. The powertrain of the EV includes four wheel assemblies (“wheels”), where each wheel assembly (“wheel”) may include an in-wheel motor 235, where each motor 235 is coupled to an inverter 240. The wheels are arranged such that the EV is configured to have two front wheels and two rear wheels.

As shown in FIG. 2, the one or more fluid conduits may form a first circuit (e.g., a front circuit) and a second circuit (e.g., a rear circuit) downstream of the at least one radiator 205, where the first circuit circulates coolant to the front wheels and the second circuit circulates coolant to the rear wheels. The circuits may be respective loops, i.e., the first circuit is a front loop and the second circuit is a rear loop. In other embodiments, the first and second circuits may instead circulate coolant to wheels on a same side of the EV. For example, the first circuit may circulate coolant to wheels on the right side of the EV and the second circuit may circulate coolant to wheels on the left side. Although some EV configurations include cooling mechanisms for cooling components, such designs may not be not suitable for cooling inverters and electric motors in series. Accordingly, the arrangement shown in FIG. 2, in which coolant flows to inverters 240 of the first circuit before the electric motors 235 of the first circuit and in which coolant flows to inverters 240 of the second circuit before the electric motors 235 of the second circuit, allows for compact thermal management of the EV powertrain. This is also advantageous due to the lower operating temperature of the inverters.

Circulation of the coolant through the first circuit or the second circuit is controlled by at least one pump. As shown in FIG. 2, the thermal control system may include a first (e.g., front) pump 215 configured to circulate coolant through the first circuit, a second (e.g., rear) pump 220 configured to circulate coolant through the second circuit, and a cabin pump 1605 configured to control a flow of coolant within the cabin circuit. Coolant, which is volume regulated by at least one vented coolant bottle assembly 210 fluidly connected to the at least one conduit, is temperature controlled within the first and second circuits by the at least one radiator 205 and at least one radiator fan 225 and at least a bypass mechanism 705 to enhance radiator heat exchange performance. Bypass mechanisms may include a valve and bypass circuit, or the use of front grid shutters. The at least one radiator 205 and the at least one radiator fan 225 are fluidly connected to the at least one conduit.

In some embodiments, the temperature of the coolant is measured by two temperature sensors, where a first temperature sensor 245 is configured to measure a temperature of the coolant upstream of the at least one radiator 205 (“T1”) and a second temperature sensor 250 is configured to measure a temperature of the coolant downstream of the at least one radiator 205 (“T2”). In various embodiments, at least one pump 215, 220, 1605, at least one heater 230, the at least one temperature sensor 245, 250, the at least one radiator fan 225, the at least one coolant bottle assembly 210, and the at least one two-way valve 1505 are coupled to at least one controller. The at least one controller is configured to monitor the temperature sensed by each of the at least one temperature sensor 245, 250 and adjust a setting of the at least one pump 215, 220 and/or the at least one heater 230. The at least one heater 230 may be a high voltage (HV) heater provided with a heater core configured to deliver hot air to the cabin 320 of the EV.

In some embodiments, the at least one controller is a controller 229 as shown in FIG. 1. The at least one controller 229 may be a plurality of controllers distributed in different locations in the EV or an integrated controller. In some embodiments, the at least one controller 229 is configured to communicate with other vehicle components as described below. In some embodiments, the at least one controller 229 is a controller in a network including a connected gateway that may be configured to receive and/or transfer information, including sensed information from a plurality of sensors and/or predetermined values stored in a database. For example, the at least one controller 229, in some embodiments, may receive information from one or more temperature sensors, pressure sensors, and level sensors, in any combination.

The at least one controller 229 may include any type and any number of wired or wireless connections. For example, a wired connection may include a serial cable, a fiber optic cable, a CATS cable, or any other form of wired connection. Wireless connections may include cellular, Wi-Fi, radio, Bluetooth, ZigBee, the Internet, etc. In at least one embodiment, the at least one controller 229 includes a controller area network (CAN) bus that provides the exchange of signals, information, and/or data between vehicle components. The CAN bus may include any number of wired and/or wireless connections. The at least one controller 229 may include a memory, a communications interface, and a processor configured to coordinate operations between the various system components. The processor and memory may be or include non-transient volatile memory, non-volatile memory, and non-transitory computer storage media. The memory may be communicably connected to the processor and may include computer code or instructions for executing one or more processes described herein.

For example, the at least one controller 229 may adjust an operational setting of the at least one heater 230 to increase an amount of heat generated by the at least one heater 230 to increase a temperature of the coolant. In particular, the at least one controller 229 may output a control command to cause the heater 230 to generate sufficient heat for the coolant temperature to rise by at least a predetermined number of degrees. In another example, the at least one controller 229 may adjust an operational setting of the at least one pump 215, 220 to increase or decrease a flow rate of the coolant within the at least one conduit. As shown in FIG. 2, the thermal control system 100 may also include at least one bypass conduit fluidly coupled to the first circuit and the second circuit, where the at least one bypass conduit permits coolant to bypass the at least one radiator 205 as it circulates through the thermal control system 100.

In some embodiments, the bypass conduit allows the coolant to bypass the radiator 205 when the electric vehicle is below a threshold temperature to supply heat to warm one of the inverter 240 or the electric motor 235. In some embodiments, the temperature of the electric vehicle is sensed by a temperature sensor located in the cabin of the vehicle and in wireless or wired communication with the controller 229. The bypass conduit may be utilized when the electric vehicle temperature is in a defined temperature range between a first temperature and a second temperature. In particular, when the temperature is in the defined range, coolant may be caused to bypass the radiator 205 to thereby warm one or both of inverter 240 or electric motor 235. In this manner, the inverter 240 or the electric motor 235 may advantageously be operated in a predefined efficiency region that is a high efficiency region.

The thermal control system 100 may include a thermal architecture configured for controlling temperature of a battery 315 and cabin 320 of the EV, as shown in FIG. 3. As shown in FIGS. 1-3, various components may be connected to each other. As illustrated, the one or more fluid conduits include a cabin circuit and a battery circuit. Refrigerant circulating through the cabin circuit facilitates temperature control of the EV cabin 320 (e.g., via one or more of an operably coupled condenser 350, radiator fan 225, and an air handler 1205) and refrigerant circulating through the battery circuit facilitates temperature control of the EV battery 315. In particular, in some embodiments, the same fan 225 is operated to cool both of the radiator 205 and the condenser 350. Thus, both the radiator 205 and condenser 350 may be cooled simultaneously by a single component in the form of the fan 225. In some embodiments, the battery 315 may be passively cooled, e.g., by radiator 205.

In various embodiments, the battery circuit may include at least one pump 305, which controls flow of coolant to the at least one chiller 325, the at least one heater 230, the battery of the EV 315, and a coupled on board charging module (OBCM) 330 in parallel with an auxiliary power module (DC-DC module) 335, which are each coupled in series within the battery circuit. In some embodiments, the battery circuit may include at least one pump 305, which controls flow of coolant to the at least one chiller 325, the at least one heater 230, and the battery of the EV 315. The OBCM 330 and the DC-DC 335 may form a circuit independently of the battery circuit. The cabin circuit may include at least one evaporator 340, a compressor 345 (e.g., a high pressure compressor), and a condenser 350, which are arranged in series. Flow of refrigerant to the at least one evaporator 340 may be controlled by at least one solenoid valve 355 coupled with a thermal expansion valve (TXV) 360 or an electronic expansion valve (EXV) 365 disposed upstream of the at least one evaporator 340. The evaporator 340 may be provided with a temperature sensor in some embodiments. The evaporator 340 may be configured to direct cold air to the cabin 320. Aspects of the battery circuit are further illustrated in FIG. 10.

In various embodiments, the cabin circuit and the battery circuit may share the same refrigerant circuit with a split solenoid valve 355 and at least one EXV 365, where refrigerant is configured to flow through a chiller 325, which is configured to decrease a temperature of the coolant, and/or flow through the evaporator 340, to cool down cabin air, according to cabin requirements. Flow of the refrigerant to the chiller 325 is controlled by the EXV 365. Accordingly, refrigerant flow through the at least one evaporator 340 and the chiller 325 may be alternately or simultaneously controlled by the TXV 360 and the EXV 365, to which a return line may be provided from the chiller 325. For example, refrigerant may flow through the at least one evaporator 340 when the TXV 360 is in an open configuration and the EXV 365 is in a closed configuration. Alternatively, refrigerant may flow to the chiller 325 when the TXV 360 is in a closed configuration and the EXV 365 is in an open configuration, or refrigerant can flow through both the TXV 306 and the EXV 365 when both are in an open configuration. A portion of the battery circuit upstream of the at least one battery pump 305 and a portion of the battery circuit downstream of the OBCM 330 may be fluidly coupled to the at least one coolant bottle assembly 210, which facilitates coolant volume regulation within the thermal control system 100. The coolant bottle assembly 210 may be provided with a level sensor configured to sense an amount of coolant contained in the bottle, which may be configured to store about 1 L of fluid in some embodiments, or a different amount. A return line is provided from the radiator 205 to the coolant bottle assembly 210. The coolant bottle assembly 210 may be communicated with the at least one controller 229 which may receive information from the level sensor and determine whether the level of coolant is less than or greater than a threshold level.

In various embodiments, control of refrigerant circulation through the cabin circuit and/or battery circuit is based on at least one of the pressure or temperature of the refrigerant within the refrigerant circuit. In some embodiments, the cabin circuit includes at least one first pressure sensor 375 and at least one temperature sensor 380 disposed downstream of the at least one evaporator 340 and/or chiller 325 and upstream of the compressor 345. At least one second pressure sensor 385 is also disposed downstream of the compressor 345. In some embodiments, another temperature sensor may be optionally disposed downstream of the compressor 345.

Each of the at least one first 375 and second 385 pressure sensors and at least one temperature sensor 380 may be operably coupled to the at least one controller such that temperature and pressure of the refrigerant within the cabin circuit measured by the at least one first 375 and second 385 pressure sensors and at least one temperature sensor 380 are received by the at least one controller 229. Accordingly, flow of the refrigerant through the cabin circuit may be adjusted (e.g., via the TXV 360 and/or the EXV 365) based on a temperature and/or pressure measured by the at least one first 375 and second 385 pressure sensors and at least one temperature sensor 380. In various embodiments, the battery 315 and/or the OBCM 330 and/or the DC-DC 335 may include one or more temperature sensors. Thus, operation of the battery pump 305 may be adjusted to control refrigerant flow through the battery circuit.

In some embodiments, a method of controlling thermal performance of an electric vehicle, in particular an electric pickup, is provided. In some embodiments, a method of operation of the thermal control system 100 includes obtaining temperature information from a plurality of temperature sensors 245, 250 by at least one of (i) monitoring the first temperature sensor 245 of the plurality of temperature sensors 245, 250 being located upstream of a radiator 205 or (ii) monitoring the second temperature sensor 250 located downstream of the radiator 205. Operating the controller includes at least one of (i) adjusting an operational setting of the heater 230 to increase an amount of heat generated by the heater 230 to increase temperature of a coolant or (ii) adjusting an operational setting of the pump 215, 220, 1605 to adjust a flow rate of the coolant through the thermal control system 100.

Additionally, in some embodiments, the method of operation of the thermal control system 100 also includes obtaining pressure information from a plurality of pressure sensors 375, 385 by at least one of (i) monitoring the first pressure sensor 375 of the plurality of pressure sensors 375, 385 and the temperature sensor 380, the first pressure sensor 375 and the temperature sensor 380 being located downstream of the evaporator 340 and upstream of the compressor 345 or (ii) monitoring the second pressure sensor 385 of the plurality of pressure sensors 375, 385, the second pressure sensor 385 being located downstream of the compressor 345. Operating the controller includes at least one of (i) adjusting the flow of refrigerant through the cabin circuit via the TXV 360 based on the pressure and temperature information from the plurality of pressure sensors 375, 385 and the temperature sensor 380 or (ii) adjusting the flow of refrigerant through a cabin circuit via the EXV 365 based on the pressure and temperature information.

Further, in some embodiments, the method of operation of the thermal control system 100 also includes operating the pump 305 to control a temperature of the battery 315. Operating the pump 305 includes controlling flow of refrigerant to the chiller 325, the heater 230, the battery 315 of the electric vehicle, the OBCM 330, and the auxiliary power module 335.

In some embodiments, the method of operation of the thermal control system 100 also includes operating the pump 215, 220, 1605 to control a temperature of the battery 315. Operating the pump 215, 220, 1605 includes circulating coolant through a circuit to cool the inverter 240 and the electric motor 235 in series such that the inverter 240 receives coolant at a cooler temperature than a temperature of coolant received by the electric motor 235. For example, the inverter 240 may receive coolant at a temperature that is at least several degrees lower than the temperature of coolant received by the electric motor 235.

It should be appreciated that the foregoing method may be modified, for example, steps may be added or omitted, or performed in a different sequence, while still falling within the scope of the present disclosure.

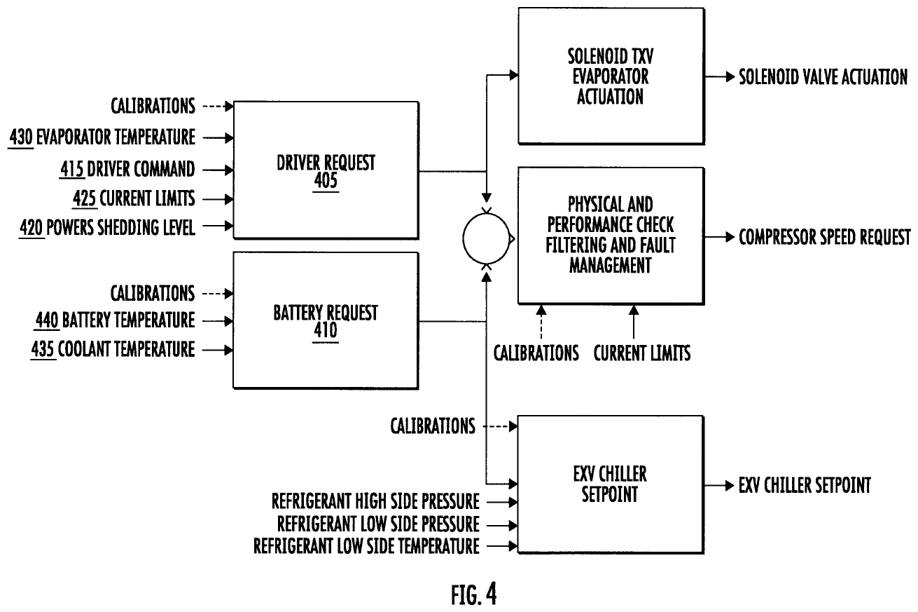

FIG. 4 shows a flow diagram depicting compressor control operations carried out by the thermal control system 100 for controlling battery and cabin temperature, according to some embodiments. The temperature of the battery 315 and the cabin 320 are influenced by the temperature of coolant or air in the system, and can be controlled based on actuation and operation of components such as the solenoid valve 355, the compressor 345 and/or the chiller 325. As shown, operation of the solenoid 355 (e.g., solenoid actuation), compressor 345 (e.g., compressor speed), and EXV chiller 325, 365 (e.g., EXV chiller set-point) is a combination of a driver request 405 or a battery request 410. Although the term “driver request” or “driver input” may be used herein, such input or request may additionally or alternatively come from any occupant of the vehicle. The driver request 405 may be a demand for a particular climate in the vehicle cabin, e.g., to perform heating to warm the cabin, for example. The driver request 405 may include an input from a driver of the EV 415, and vehicle internal signals such as a power shedding level 420, a current limit 425, a temperature set-point 430, or another command or input. The additional command or input may be calibration data provided by the controller 229 relating to operation of the relevant component. The controller 229 may issue an instruction for control of one or more components for calibrating at least one performance aspect or parameter, in the form of a calibration input. The power shedding level 420 and current limit 425 are related to EV battery health. The power shedding level 420 and current limit 425 may be based on sensed information and/or predetermined values stored in a database. The battery request 410 may comprise an input from at least one of a coolant temperature 435 (e.g., as measured by a sensor within the battery circuit) or a battery temperature 440 (e.g., as measured by a sensor integrated with the battery 315).

Accordingly, operation of the solenoid 355, compressor 345, and/or chiller 325 may be controlled to adjust a temperature of coolant or air flowing through the thermal control system 100 based on inputs from the driver of the EV 415 and/or based on a current temperature of the EV battery 440. In some embodiments, the other commands or input may be provided by the at least one controller 229 and may be provided through a communication area network (CAN). In particular, the various requests, commands or inputs discussed herein may be provided via a CAN bus application layer protocol. In some embodiments, the TXV 360 and both the driver request 405 and the battery request 410 may be used to control one or more of the evaporator 340, the TXV 360 or the solenoid valve 355. The at least one controller 229 may be configured to provide a command to actuate the solenoid valve 355 in response to the combination of the driver request 405 and the battery request 410. In some embodiments, one or more of the following evaluation or control activities may be performed: (i) diagnostic evaluation, (ii) physical evaluation, (iii) performance checking, (iv) filtering and/or (v) fault management, alone or in any combination. These activities may be performed based on the combination of the driver request 405 and the battery request 410, in addition to current limit information and additional input from the at least one controller 229. The controller 229 may command the compressor 345 to operate at a particular speed responsive to the result of the specific diagnostic or performance checking activity performed. Further, in some embodiments, a setpoint for the EXV 365 or chiller 325 may be determined responsive to information relating to a refrigerant high side pressure, a refrigerant low side pressure, and a refrigerant low side temperature. The EXV 365 and/or chiller 325 may be controlled to operate at the setpoint.

Both the condenser 350 and the radiator 205 may be fluidly coupled to a radiator fan 225, which accelerates thermal exchange by the coolant and/or refrigerant. FIG. 5 shows a flow diagram depicting radiator fan 225 control operations carried out by the thermal control system 100 for controlling battery 315, inverters 240, motors 235, and cabin temperature. The temperature of coolant or air in the thermal control system 100 may thus be adjusted through input from the occupant as well as the battery temperature. As shown, radiator fan 225 speed may be adjusted based on a maximum value determined between an input from the at least one condenser 350 and an input from the radiator 205. The input from the condenser 350 may be based on at least one input from the at least one compressor 345 (e.g., a current compressor speed 505) and a compressor speed request, and/or other input. The input from the radiator 205 may be based on at least one of a powertrain temperature 510 (e.g., as determined by the first 245 and/or second 250 temperature sensors within the first or second circuits), a radiator input temperature 515 (e.g., T1), or an after run condition 520, when the powertrain should be cooled down after stopping. Thus, a control command for the HVAC system may be determined based on the combination of the occupant/driver input and of one or more of a predetermined or sensed current limit, a power shedding level, and a radiator input temperature 515. In some embodiments, the input from the radiator is based on at least the powertrain temperature 510, the radiator input temperature 515, the after run condition 520 and other input. In some embodiments, (i) physical evaluation, (ii) performance checking, (iii) filtering and/or (iv) fault management may be performed using the maximum value information in addition to further input from the controller 229 and power shedding level information. The fan speed of radiator 225 may be controlled responsive to the information from one or more of the (i) physical evaluation, (ii) performance checking, (iii) filtering and/or (iv) fault management.

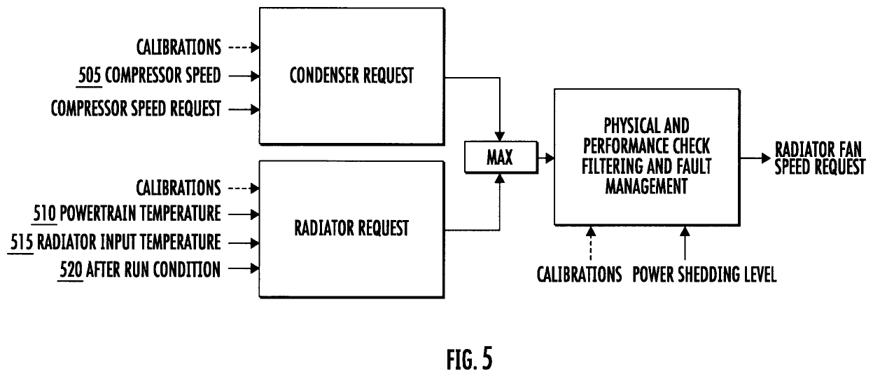

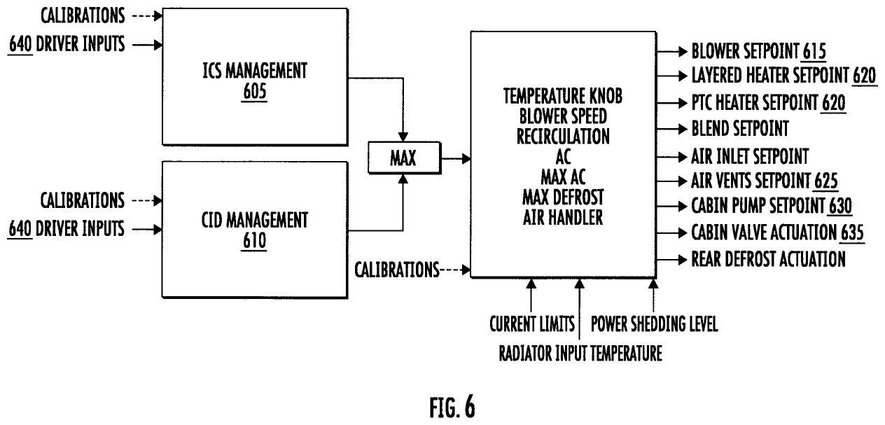

In various embodiments, control of the heating, ventilation, and air conditioning (HVAC) of the EV may be performed using coolant and refrigerant within the thermal control system 100. FIG. 6 depicts a flow diagram of the HVAC operations carried out by the thermal control system 100 for controlling cabin temperature. As illustrated, EV occupant inputs to at least one human-machine interface (HMI) system (e.g., integrated center stack (ICS) management 605, center information display (CID) management 610), combined with predetermined or sensed current limits, power shedding levels, and/or radiator input temperature 245 (e.g., T1) may cause the HVAC system to adjust one or more of a blower setpoint 615 from a blower as shown in FIG. 1, heater setpoint 620, air vent setpoint 625, pump setpoint 630, and/or valve setpoint 635. In particular, one or more setpoints such as the blower setpoint 615, heater setpoints 620, a blended setpoint, an air inlet setpoint, an air vent setpoint 625, a cabin pump set point 630, a cabin valve actuation 635 and a rear defrost actuation may be controlled based on one or more of a temperature knob level, blower speed level, a recirculation of air setting, an air conditioner (AC) setting, a maximum AC setting, a maximum defrost level and an air handler setting. These may in turn be controlled using a maximum value from the ICS 605 and CID 610 management (each based on driver input, among other information), as well as current limits, a radiator input temperature and a power shedding level. The ICS 605 and the CID 610 may be managed by controllers that may be integrated in, sub-controllers of, or separate from controller 229.

In at least one embodiment, the HMI system may be configured to communicate with an integrated center module configured to allow control of the HVAC system. The HMI system may also be configured to allow control of audio settings for the cabin 320 of the vehicle by the occupant of the vehicle. Alternatively or additionally, the HMI system may be configured to communicate with a display to allow control of the HVAC system, the audio settings, and other vehicle settings, wherein the display is a touch-screen display. Adjustments by the HVAC system responsive to predetermined and/or sensed metrics, combined with driver input 640, may accordingly contribute to temperature changes within the EV cabin 320 by causing adjustments in coolant flow and refrigerant. Specifically, adjusting the HVAC system may include performing cooling, through a circuit configured to facilitate cooling the inverter 240 and the electric motor 235 in series such that the inverter 240 receives coolant at a cooler temperature than a temperature of coolant received by the electric motor 235.

As previously described, coolant flow through the thermal control system 100 is controlled by various pumps fluidly connected to the one or more conduits within the thermal control system 100. As illustrated in FIG. 7, which shows a flow diagram depicting pump control operations carried out by the thermal control system 100 for controlling powertrain, battery, and cabin temperature, according to an exemplary embodiment. Flow of coolant within the thermal control system 100 is controlled by the first pump 215 (“powertrain front pump control” 215), second pump 220 (“powertrain rear pump control” 220), a radiator bypass valve control 705 (e.g. three-way valve), a cabin pump control and cabin valve 210 (e.g., coolant bottle assembly 210), and a battery pump control 305 (e.g., the battery pump 305).

As shown, operation (e.g., speed) of the first pump 215 may be based on one or more temperature inputs 730 from at least one inverter 240 and/or electric motor 235 within the first circuit, and operation (e.g., speed) of the second pump 220 may be based on one or more temperature inputs 735 from at least one inverter 240 and/or electric motor 235 within the second circuit. Furthermore, actuation of the radiator bypass valve 705 may be determined based on at least one of the inverter or electric motor temperatures 730, 735 from the first or second circuit. The cabin pump control and cabin valve 210 may be controlled based on one or more inputs from the at least one controller based on a desired HVAC setting or strategy. Similarly, the operation of the battery pump control 305 may be adjusted based on a battery temperature 740.

FIG. 8 shows a perspective view of the first and second circuits within the powertrain thermal architecture of the thermal control system 100 for the EV. As illustrated, the first and second circuit may be fluidly connected near the radiator 205 and separately routed to the cabin heating circuit with a coolant bottle assembly 210 and pump 215, 220 (i.e., via the second circuit) and the front and rear inverters 240 and electric motors 235 (i.e., via the first circuit).

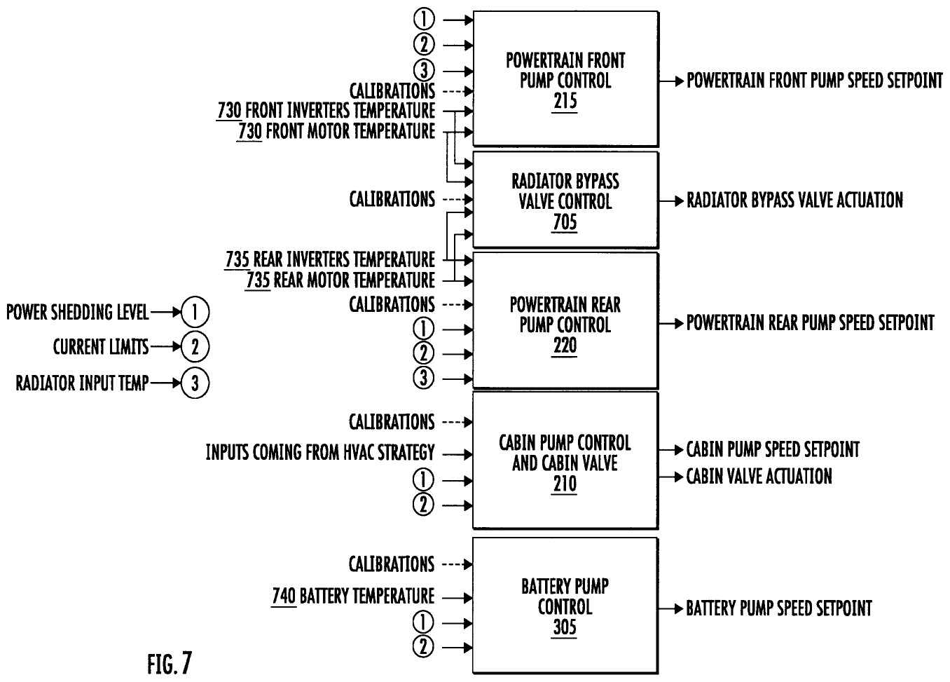

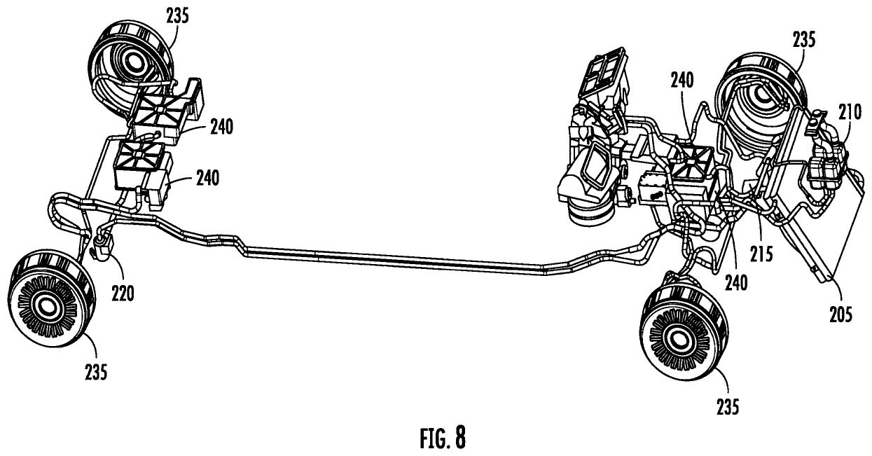

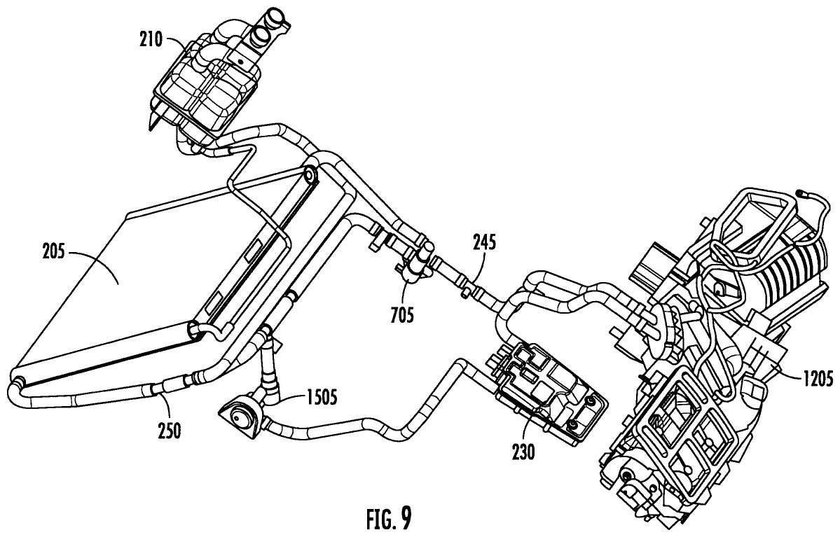

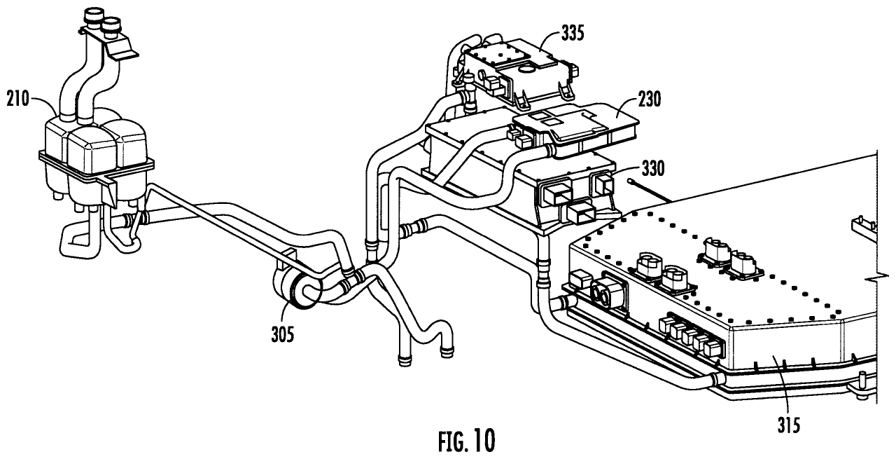

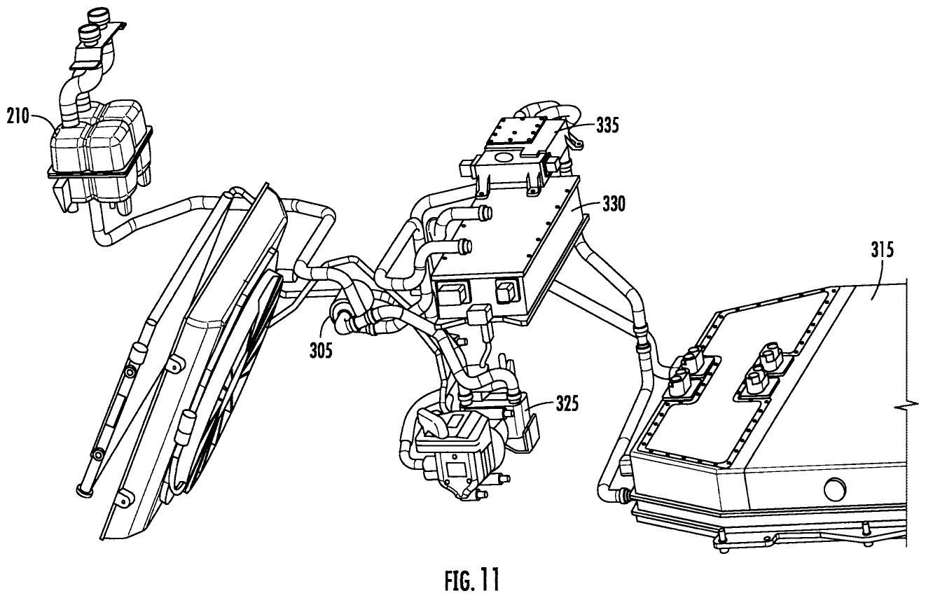

As illustrated in FIG. 9, the cabin circuit is fluidly coupled to the radiator 205, which is disposed between the first 245 and second 250 temperature sensors. As shown, the at least one coolant bottle assembly 210 is both fluidly coupled to the cabin circuit (as shown in FIG. 9) and to the battery circuit, as shown in FIGS. 10 and 11. The at least one coolant bottle assembly 210 is fluidly coupled to one or more plumbing lines between the chiller 325 and the OBCM 330/DC-DC module 335, and between the chiller 325 and the battery pump 305, as shown in FIG. 11.

As shown in FIG. 12, the cabin circuit includes one or more plumbing lines coupled between an air handler 1205, which outputs conditioned air to the EV cabin, condenser 350, compressor 345, and evaporator 340. In various embodiments, the TXV 360 and/or the solenoid valve 355 may be operated to control flow of coolant through the cabin circuit to facilitate cabin climate control based on at least one of a temperature or pressure sensed by respective first 375 and second 385 pressure sensors and at least one temperature sensor 380 disposed within the cabin circuit.

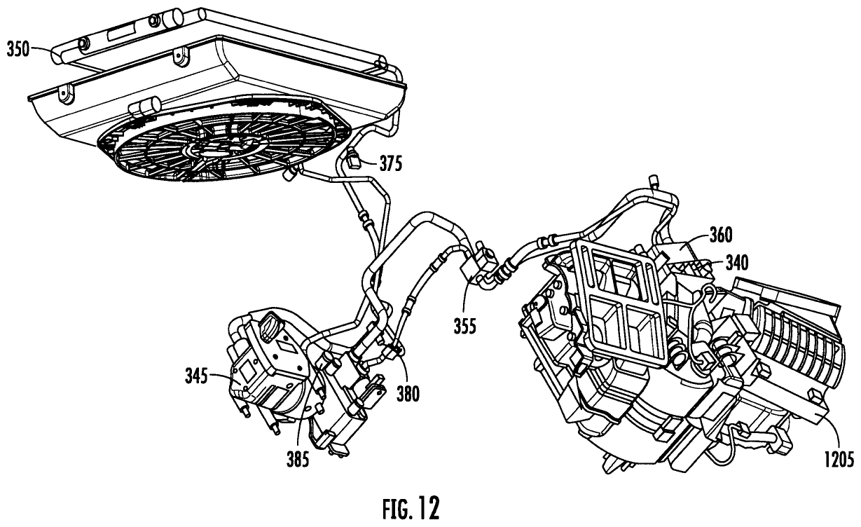

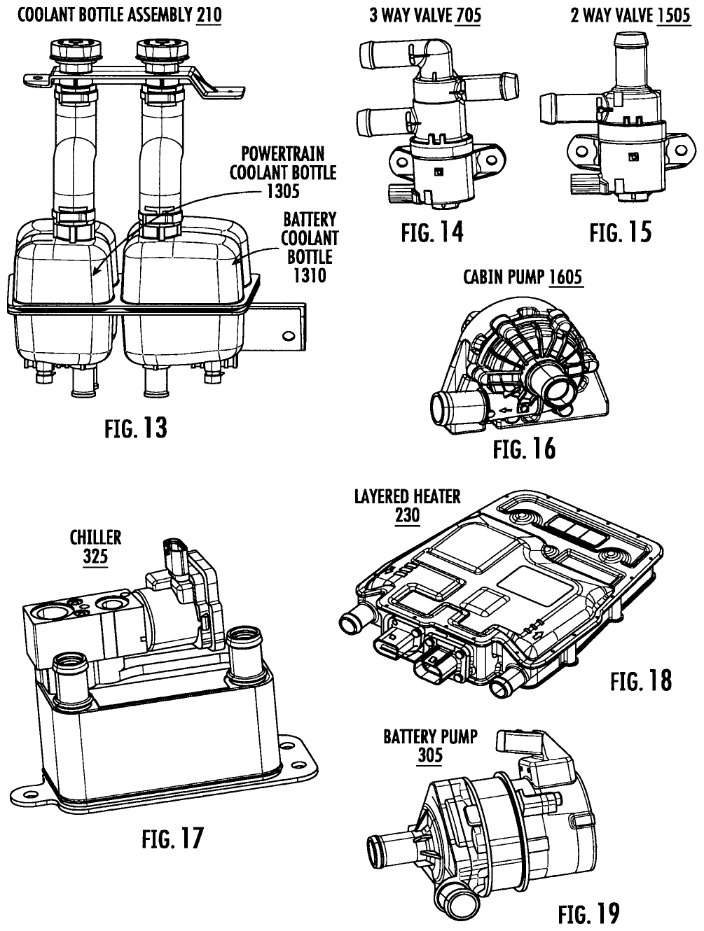

As previously described, the thermal control system 100 controls volume of coolant via at least one coolant bottle assembly 210, which is shown in FIG. 13. The at least one coolant bottle assembly 210 may include a first bottle 1305 for receiving and controlling a volume of coolant from within the powertrain architecture (i.e., coolant from within the first circuit and second circuit) and a second bottle 1310 for receiving and controlling a volume of coolant from within the battery circuit. Flow of coolant within the powertrain layout may be controlled by one or more three-way valves 705 (such as shown in FIG. 14) and/or two-way valves 1505 (such as shown in FIG. 15). Flow of coolant within the cabin circuit may be controlled by the cabin pump 1605 shown in FIG. 16.

As described above, a temperature of coolant within the thermal control system 100 may be lowered or increased based on operational settings of the chiller 325 (shown in FIG. 17) and/or a layered heater 230 (shown in FIG. 18). A flow rate of coolant to the chiller 325 and/or layered heater 230 may be controlled by the battery pump 305 shown in FIG. 19, which is in fluid connection with the chiller 325 and the layered heater 230. In some embodiments, the EV may be equipped with one or more regenerative braking mechanisms, where the regenerative braking mechanisms may be configured to utilize heat and/or energy generated during braking to charge the EV battery 315. In instances when the EV battery 315 is fully charged, the regenerative braking mechanisms may instead provide the heat generated during braking to at least one of the powertrain layout (e.g., the first and/or second circuits), the battery circuit, or the cabin circuit. Accordingly, heat generated during braking may be used by the thermal control system 100 to heat the battery 315, the cabin 320, or components within the powertrain.

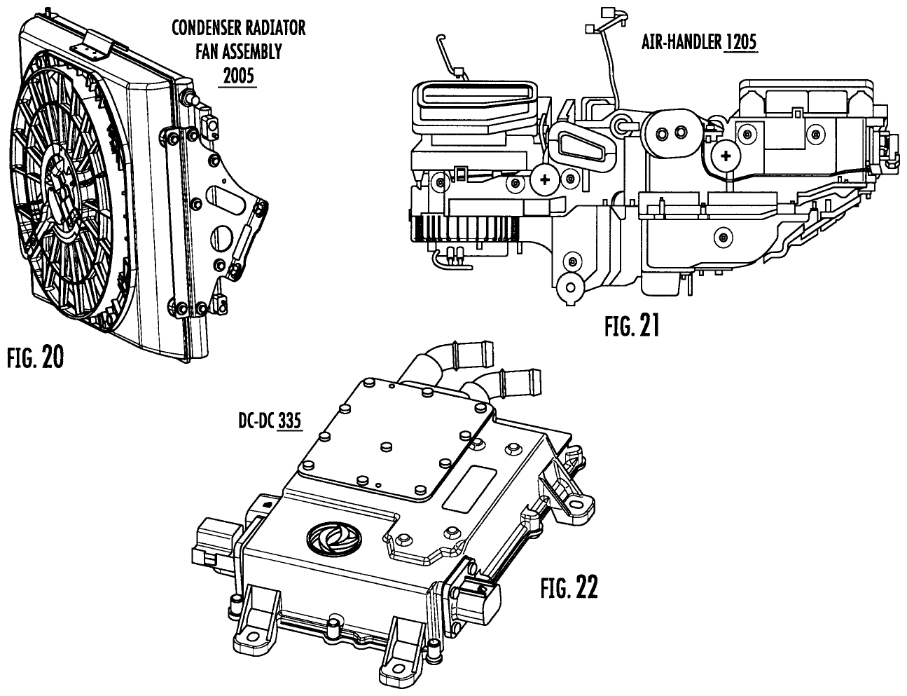

In various embodiments, the condenser 350, radiator 205, and radiator fan 225 may be coupled to form an assembly 2005, as shown in FIG. 20. Accordingly, coolant within the thermal control system 100 may be cooled by the condenser, radiator, and fan assembly 2005 to facilitate cooling of one or more components within the EV. As previously described, the thermal control system 100 may be coupled to at least one air handler 1205 (such as shown in FIG. 21), which is coupled to the cabin circuit. Accordingly, air within the air handler 1205 may be heated and/or cooled responsive to heated or cooled coolant flowing through the cabin circuit. The temperature of air supplied to the cabin 320 may be controlled based on occupant input and other factors, such as battery temperature, for example.

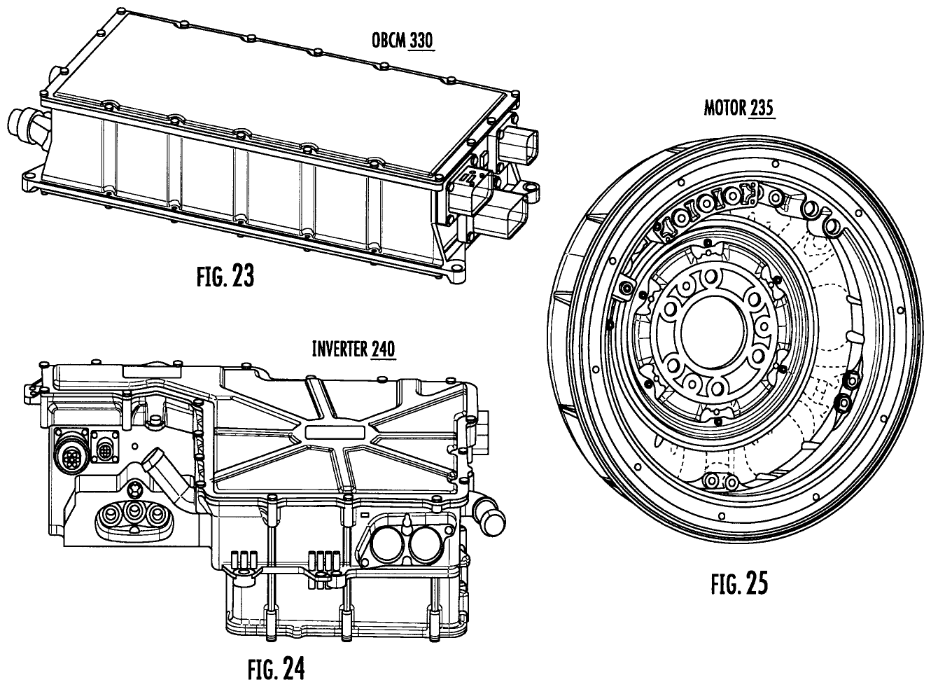

In various embodiments, components of the EV powertrain include at least one auxiliary power module DC-DC 335 (such as shown in FIG. 22), which may be operably coupled to the OBCM 330 (as shown in FIG. 23). Various other embodiments of the EV may include more or fewer powertrain components. As previously described, the EV may include at least one inverter 240 and at least one motor 235, which are respectively shown in FIGS. 24 and 25. In some embodiments, each wheel of the EV may be controlled by or operably coupled to its own respective inverter 240 and motor 235 (specifically, an in-wheel hub motor).

In various embodiments, one or more of the pumps 215, 220, 1605, 305 within the EV may be cooperatively controlled by a single controller. In other embodiments, one or more of the pumps 215, 220, 1605, 305 may be separately controlled by respective controllers to facilitate independent monitoring and control of coolant flow to each of the powertrain, battery 315, and/or cabin 320 of the EV. In some embodiments, the one or more pumps 215, 220, 1605, 305 may each be coupled to one or more controllers, where the one or more controllers are configured to receive one or more inputs from within the EV and one or more inputs from a driver of the EV.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various steps described herein.

It should be noted that the term “example” as used herein to describe various embodiments is intended to indicate that such embodiments are possible examples, representations, and/or illustrations of possible embodiments.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, assembly and arrangement of the various exemplary embodiments without departing from the scope of the embodiments described herein.

While this specification contains implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A thermal control system for an electric vehicle configured to circulate coolant within the electric vehicle, the electric vehicle comprising:
a powertrain configured to receive coolant comprising:
a wheel assembly comprising:
an inverter; and
an electric motor coupled to the inverter;
a circuit configured to facilitate cooling the inverter and the electric motor in series such that the inverter receives coolant at a cooler temperature than a temperature of coolant received by the electric motor;
a cabin configured to receive the coolant after the coolant is received by the electric motor;
a battery circuit configured to control the temperature of a battery system;
a bypass conduit configured to allow coolant to bypass a fluidly coupled radiator;
a radiator bypass valve; and
at least one temperature sensor configured to sense a temperature within the electric vehicle.

2. The system of claim 1, wherein the circuit is a front circuit, a rear circuit, or a cabin circuit.

3. The system of claim 2, wherein the front circuit connects two wheel assemblies of the electric vehicle, and the rear circuit connects two wheel assemblies of the electric vehicle.

4. The system of claim 2, wherein the front circuit connects two wheel assemblies on one side of the electric vehicle, and the rear circuit connects two wheel assemblies on the opposite side of the electric vehicle.

5. The system of claim 2, wherein the cabin is configured to receive the coolant via the cabin circuit after the coolant is received by the electric motor to reduce energy consumption while heating the cabin.

6. The system of claim 2, wherein the bypass conduit is fluidly coupled to the first circuit and the second circuit, and wherein coolant is configured to bypass the fluidly coupled radiator when the electric vehicle is below a threshold temperature to supply heat to warm one of the inverter or the electric motor such that the inverter or the electric motor is operated in a predefined efficiency region.

7. The system of claim 6, wherein actuation of the radiator bypass valve is determined based on the temperature of at least one of the inverter or the electric motor from the front circuit or the rear circuit.

8. The system of claim 1, wherein one temperature sensor is located downstream of the evaporator and upstream of the compressor.

9. The system of claim 1, wherein one temperature sensor is located upstream of the fluidly coupled radiator, and another temperature sensor is located downstream of the fluidly coupled radiator.

10. The system of claim 9, wherein the temperature sensors are configured to communicate with a controller to facilitate flow rate control of the coolant in the vehicle.

11. A method of operation of a thermal control system for an electric vehicle, comprising:
obtaining, by at least one controller, temperature information from a plurality of temperature sensors including a first temperature sensor and a second temperature sensor, wherein obtaining the temperature information comprises monitoring at least one of the first temperature sensor, which is located upstream of a radiator, or the second temperature sensor which is located downstream of a radiator;
adjusting an operational setting of (i) a heater to increase an amount of heat generated by the heater to cause the temperature of coolant in the thermal control system to rise, or (ii) a pump to adjust a flow rate of coolant through the thermal control system;
obtaining, by the at least one controller, pressure information from a plurality of pressure sensors, wherein obtaining the pressure information comprises at least one of monitoring a first pressure sensor of the plurality of pressure sensors and a temperature sensor both located downstream of an evaporator and upstream of a compressor, or monitoring a second pressure sensor of the plurality of pressure sensors, the second pressure sensor located downstream of a compressor; and
adjusting the flow of refrigerant through a cabin circuit via a thermal expansion valve (TXV) based on at least one of the pressure and temperature information from the plurality of pressure sensors and the temperature sensor or via an electronic expansion valve (EXV) based on the pressure and temperature information.

12. The method of claim 11, further comprising:
operating a pump to control a temperature of a battery, wherein operating the pump comprises:
controlling flow of refrigerant to one or more of a chiller, a heater, a battery of the electric vehicle, an on-board charging module, and an auxiliary power module; and
controlling temperature of a powertrain of the electric vehicle by circulating coolant through a circuit to cool an inverter and an electric motor in series such that the inverter receives coolant at a cooler temperature than a temperature of coolant received by the electric motor.

13. The method of claim 12, wherein adjusting the temperature of coolant or air flowing through the thermal control system is based on input from an occupant of the electric vehicle and/or a temperature of the battery.

14. The method of claim 11, wherein controlling a temperature of the battery and the cabin includes controlling one or more of a solenoid, the compressor, and/or the chiller to adjust a temperature of coolant or air flowing through the thermal control system, and wherein the circuit is a front circuit or a rear circuit.

15. The system of claim 14, wherein the front circuit connects two front in-wheel motors of the electric vehicle, and the rear circuit connects two back in-wheel motors of the electric vehicle, where each in-wheel motor is coupled to an inverter.

16. The method of claim 14, wherein the front circuit connects two in-wheel motors on one side of the electric vehicle, and the rear circuit connects two in-wheel motors on the opposite side of the electric vehicle, where each in-wheel motor is coupled to an inverter.

17. The system of claim 11, wherein the cabin is configured to receive the coolant via the cabin circuit after the coolant is received by the electric motor.

18. A method of operation of a heating, ventilation, and air conditioning (HVAC) system for an electric vehicle having an electric motor and an inverter, the method comprising:
inputting, via an occupant of the vehicle, an input to a human-machine interface (HMI) system;
determining a control command based on the combination of the occupant input and of one or more of a predetermined or sensed current limit, a power shedding level, and a radiator input temperature; and
adjusting the HVAC system based on the control command, wherein adjusting the HVAC system comprises performing cooling, through a circuit configured to facilitate cooling the inverter and the electric motor in series such that the inverter receives coolant at a cooler temperature than a temperature of coolant received by the electric motor.

19. The method of claim 18, wherein the HMI system is configured to communicate with an integrated center module configured to allow control of the HVAC system and is further configured to allow control of audio settings for a cabin of the vehicle by the occupant of the vehicle.

20. The method of claim 18, wherein the HMI system is configured to communicate with a display to allow control of the HVAC system, the audio settings and other vehicle settings, wherein the display is a touch-screen display.
